(19) United States
(12) Patent Application Publication
(10) Pub. No.: US 2006/0037519 A1
(43) Pub. Date: Feb. 23, 2006

(54) Security door and frame construction

(76) Inventor: Brett Dunstan, Victoria (AU)

Correspondence Address: D. PETER HOCHBERG CO. L.P.A., 1940 EAST 6TH STREET, CLEVELAND, OH, 44114, US

(21) Appl. No.: 10/530,467

(22) PCT Filed: Oct. 8, 2003
(86) PCT No.: PCT/AU03/01321

§ 371 Date: Apr. 6, 2005

(30) Foreign Application Priority Data
Oct. 9, 2002 (AU) 2002951987
Apr. 30, 2003 (AU) 2003902027

(51) Int. Cl. E06B 3/36

(52) U.S. Cl. 109/74

(57) ABSTRACT

This security door construction is applicable to safes, factory doors and house doors. An offset hinge assembly allows the door to swing open and closed and also to slide in and out of a door slot in the door frame at the closing edge of the door. In the construction of a safe, hooks on the inside of the door enter slots in upstands inside the safe and engage and disengage through the sliding motion. House doors and screen doors use a hinge assembly which operates in the same way as the safe. One pair of hinges are fixed to the frame and the second pair of hinges are fixed to the door. The frame and door pairs are connected by a rod or tube which ensures that the hinge axis of the door pair remains parallel to the hinge axis of the frame pair. A door locking mechanism is actuated by a conventional pneumatic door closer. A gas strut supplies the thrust to cause the mechanism to slide the door into the door slot when the door closer brings the door into register with the door slot.

### FIELD OF THE INVENTION

This invention concerns security door and frame construction and relates to safes.

### BACKGROUND OF THE INVENTION

Provision for security in doors include measures such as making the door and frame resistant to attack, providing special locks and adding multiple bolts which shoot into the frame. Such measures are effective in their own way and intruders devise counter measures as new security equipment becomes available.

EP 0665 356 A1 discloses a safe wherein the door is wider than the door opening and lies behind the door opening when closed. The door is mounted on a vertical shaft which spans the door opening and reduces the effective opening width of the door. Pins extending from the interior face of the door engage slots in a mount which pivots on the shaft and a crank turned by a handle on the exterior face of the door slides the door on the mount. As the door clears the door opening, it is free to tilt inwards into the safe. The door swings on the mount and gives access to the safe interior. This mechanism reduces access to the safe interior and still requires a conventional bolt system to prevent the door from being forced inwards. The fall weight of the door is carried by the mount. The handle must displace the entire mass of the door sideways in order to clear the door opening.

### SUMMARY OF THE INVENTION

This invention provides a security door construction comprising a door and door frame when a door is mounted on an offset hinge and the upright of the frame opposite the hinge has a slot capable of receiving the closing edge of the door, which upon closing slides into the slot and upon opening slides out of the slot.

The slot need only be shallow in that the admission of the margin of the closing edge of the door ensures a large area of engagement between door and frame and a correspondingly large force to displace the door.

The slot may be a 5-12 mm metal door such as is used for a safe. The timber door slot depth may be somewhat greater. The hinge axis is not coincident with the longitudinal edge of the door as in a conventional door. The hinge is offset from the door surface. The throw of the hinge may be 15-25 mm to give the required sliding entry and exit.

When the construction is used in a metal safe, the hinges may be paired conventionally but connected to the door face. The hinges may be connected to the door by a mounting member which provides the offset. The mounting member may be a tube or rod which maintains the hinge axis of the frame hinges parallel to the axis of the door hinges. The invention also provides the feature that the door frame has a frame rail behind the top edge and bottom edges of the rear face of the door, each rail has a slot means and the corresponding area on the rear face of the door have hook means for engaging and disengaging when the door closes and opens.

The top and bottom hinges may be protected by a hinge box fixed to the face of the door.

The door may have a conventional lock with a bolt and a keeper in the door frame. Multiple sliding pin locks may be fitted, but these are not necessary due to the extensive door margin engagement of the slot.

Door and frame construction of this type is particularly applicable to small box safes of the type used to store narcotics, cash and firearms, but is able to support doors on thicker metal safes. One application is now described pertaining to gun safes.

The uprights of the frame may be box-section styles. The door slot may be in the closing style. The body of the safe may be made of a single plate panel which is formed into a channel shape, including the box-section styles braced by a top plate and a bottom plate.

The hinge mounts may be mounted on the floor and the roof of the safe and extended to the safe interior. Each hinge may be part of a flange welded to the floor and roof The hinges are joined in order to preserve the axis of rotation of the door which would otherwise sag randomly and tilt the plane of the door preventing orderly opening and closing.

The door may be a metal plate connected by a pair of door hinges to a pair of frame hinges. Mounts for the frame hinges are located adjacent the door support style and the gap between the door and style is closed up when the door is locked.

The frame hinges and the door hinges connected thereto are preferably protected by a box extending the full length of the door. The door may be stiffened by a box brace fixed to the interior face of the door. A conventional lock may shoot a bolt into the door closing style.

In some safes and security doors, security could be improved if their operation was made fail safe. The door construction described above may be modified to fail safe by fitting a conventional door closer inside the safe and provision of a thruster which slides the door into the slot. The sliding motion must be delayed until the door is in register with the slot otherwise the door will strike the closing style and never reach the slot. The construction may have a door closer arranged to swing the door shut and a biassing assembly associated with the door capable of sliding the door into the door slot when the door closer brings the door into register with the door slot.

The biassing assembly may impart a sliding motion to the door when the door lands on the closing surface parallel to the plane of the closed door against which the door swings to close before the door reaches the door slot. In such an arrangement, the biassing assembly preferably comprises a door handle with a crank inside the door which reacts against the rod or tube extending between the frame pivots, biassing means acting between the inside of the door and the crank in order to urge the door to slide toward the door slot, a link assembly connected to the crank which restrains the biassing means from imparting such slide motion to the door and a stop extending over at least part of the doors arc of swing which releases the link assembly at the end of the arc when the door registers with the door slot.

### BRIEF DESCRIPTION OF THE DRAWINGS

Various embodiments are now described by way of example with reference to the accompanying drawings, in which:

FIG. 1 is a perspective view of a small cash safe with a door closed.

FIG. 2 is a perspective view of a safe of FIG. 1 with the door open.

FIG. 3 is a front view of the hinge assembly of FIG. 2 from direction A.

FIG. 4 is an exploded view of the hinge assembly of FIG. 3 after welding.

FIG. 5 is a sectional plan of the safe with the door closed.

FIG. 6 is a sectional plan of the safe with the door moved sideways.

FIG. 7 is a sectional plan of the safe with the door opening.

FIG. 8 is a sectional plan of the safe with the door fully open.

FIG. 9 is a sectional plan of the safe door with the handle for opening and closing the door.

FIG. 10 is a front view of a fragment of the safe showing the handle linkage to the hinge assembly.

FIG. 11 is a sectional plan of a timber door and casing with the door closed.

FIG. 12 is a sectional plan of the door and casing of FIG. 11 with the door open.

FIG. 13 is a sectional plan of an aluminium security door with the door closed.

FIG. 14 is a front view of a hinge assembly for the door of FIG. 13 which is also supplied as a separate component for a suitable door and casing.

FIG. 15 is a front view of a triple hinge layout.

FIG. 16 is a diagrammatic perspective view of a gun safe showing the hinge assembly.

FIG. 17 is a front sectional view of the hinge of FIG. 16.

FIG. 18 is a sectional plan of a two door safe with a central pillar.

FIG. 19 is a plan view of a steel plate door.

FIG. 20 is a perspective partly sectioned view of the upper part of the door shown in FIG. 19.

FIG. 21 is a rear view of a safe containing the mechanism looking through the safe with the back removed.

FIG. 22 is a plan of the safe of FIG. 1 looking from Direction A.

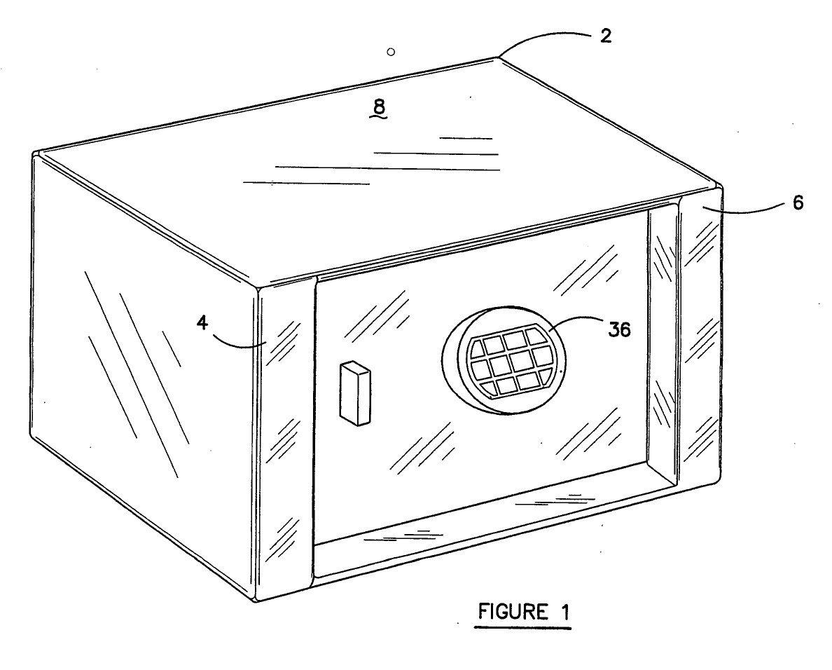

### DETAILED DESCRIPTION WITH RESPECT TO THE DRAWINGS

Referring now to the drawings, the safe body 2 is made of 2 mm steel plate which is rolled into a channel section with the edges turned to form further channelled section styles 4, 6. The safe is closed by a top plate 8 and a bottom plate 10 welded to the body. The styles are therefore resistant to being forced apart by a jacking force applied between them.

The closing style 4 has three sides. The fourth side is formed by a box section steel closer 12 welded to the body and projecting beyond the closing style. The 4 mm gap 14 between the closer and the style extends the full length of the 3 mm steel plate door 16.

Flanges 18, 20 are inset and welded to the floor and roof. These support frame hinges 22,24. The door tilts on hinges 26, 28 which are welded at their ends to the roof and floor. The pins of the frame hinges 22,24 are joined by rod 30. The pins of the door hinges 26,28 are joined by rod 32.

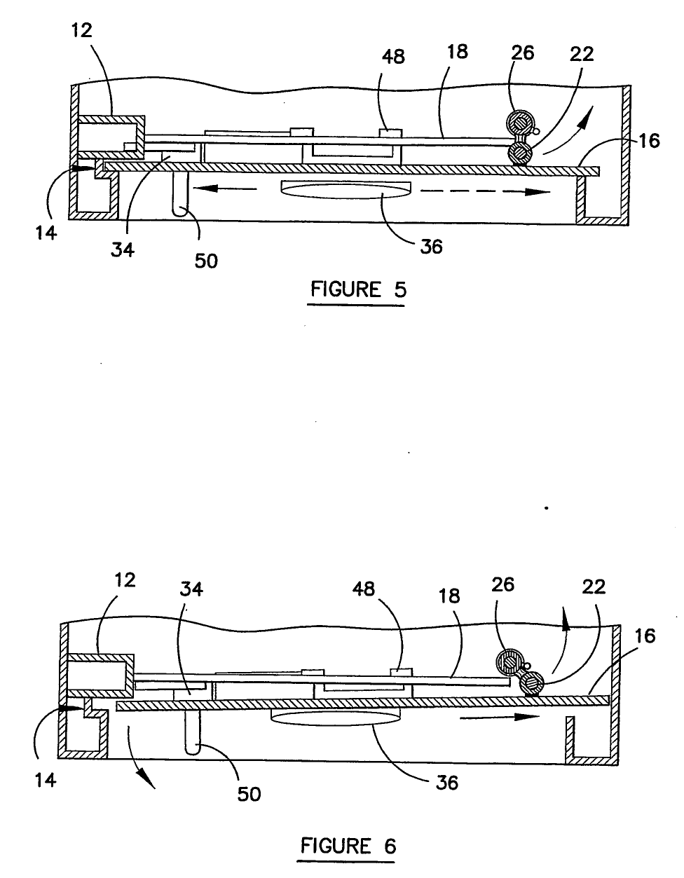

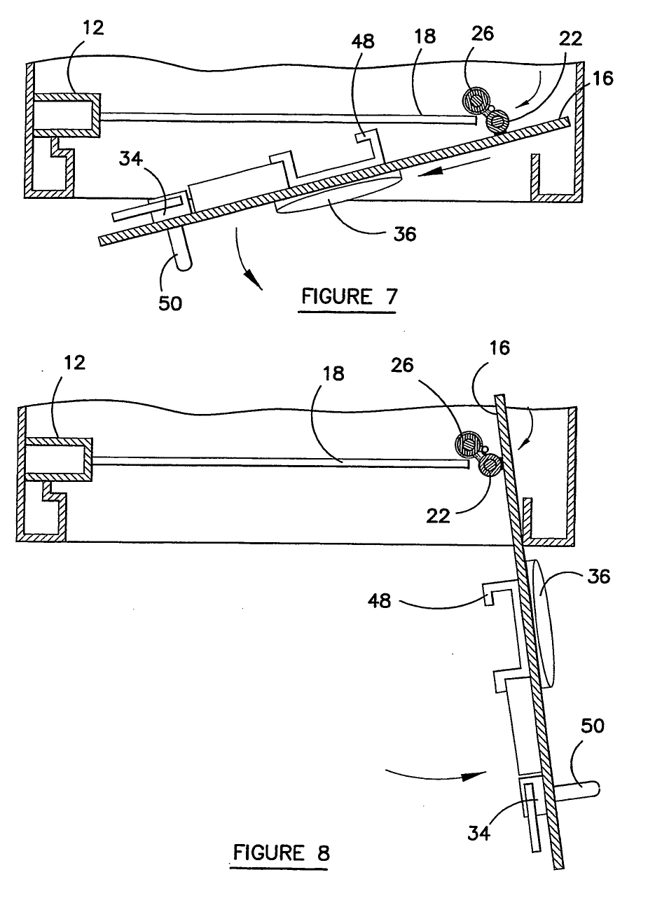

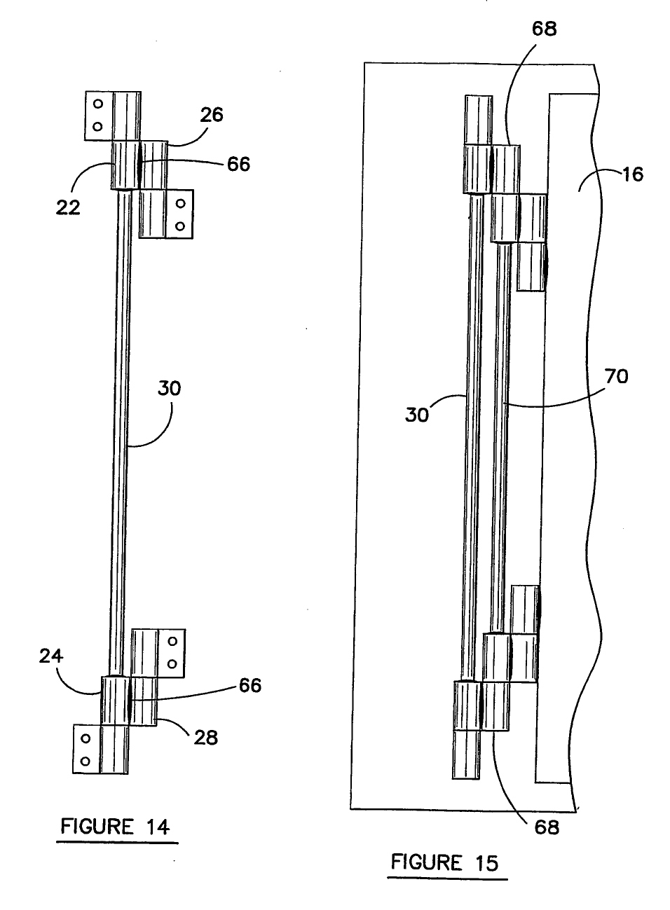

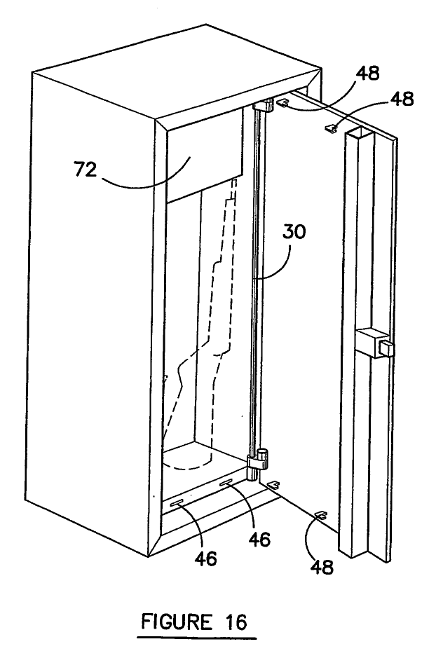

The sequence of opening the door is seen in FIGS. 5, 6, 7 and 8. The joining of rods 30 and 32 produces a throw in the hinge of about 20 mm and the door moves about half of this distance into slot 14. The lock 34 is conventional and is operated by keypad 36. Without the rigidity of the joined rods 30,32, the door would sag and resist opening and closing. This rigidity can be achieved variously by other geometries (see FIGS. 14 and 16).

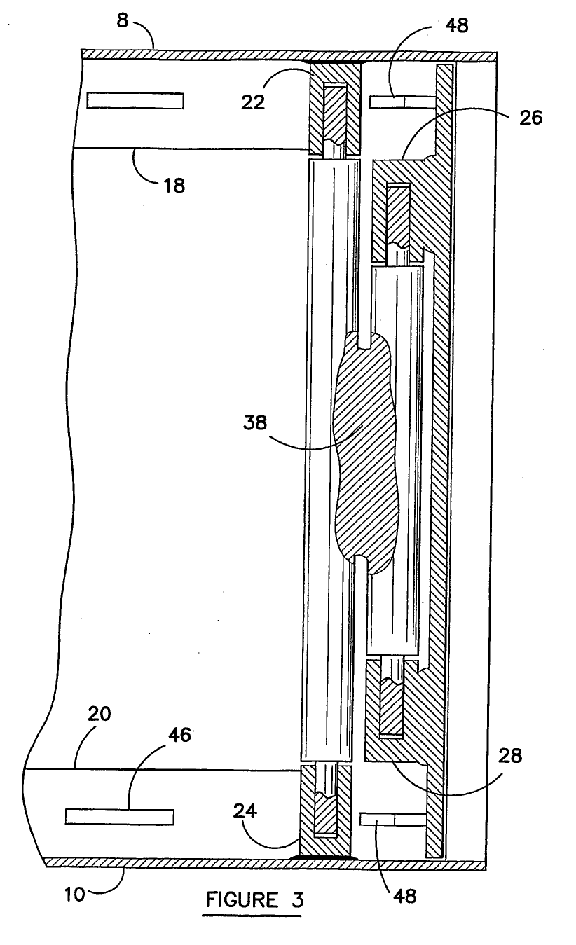

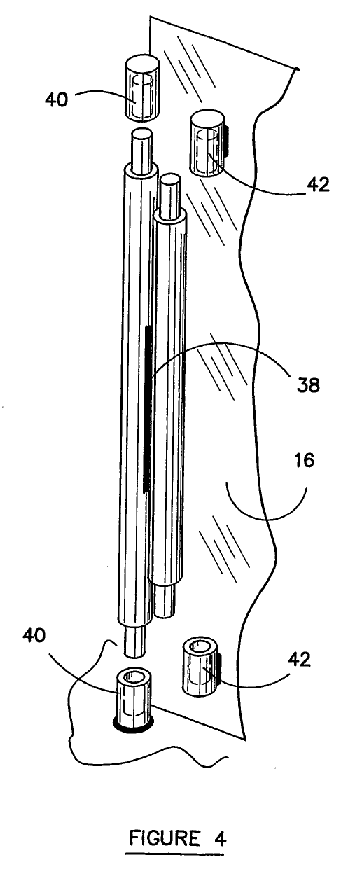

In FIGS. 3 and 4, the rods are joined by a common weld 38. In this version, the rods join the pins 38 of the frame hinges to the pins of the door hinges. In manufacture, the sequence is as follows.

The body of the safe is rolled to form the edges of the door. The top and the floor are welded in position. The rods are welded together in a jig. The hinge collars are added and the hinge assembly is offered up to the door and welded to the door.

The door assembly is then offered up to a jig which also receives the body and then upstands 18, 20 and frame hinges are welded to the body. Hinge pockets 42 abut the upstands and are welded to the roof and floor. The door assembly is offered up to the safe opening and pockets 42 abut the upstands and are welded to the roof and floor.

Upstands 18 and 24 have slots 46 for the reception of hooks 48 which engage and disengage the slots as the door opens and closes. The hook and slot engagement is in addition to the conventional lock.

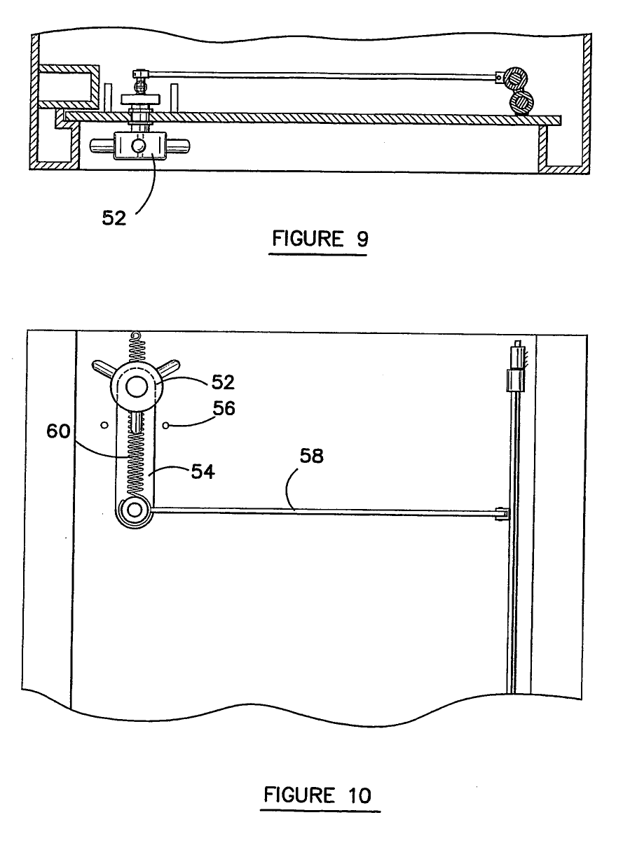

The sliding motion of the door is initiated by the person opening the safe, usually by exerting pressure on a D-handle 50 (FIGS. 5-8). In FIG. 9, handwheel 52 turns crank 54 between stops 56 and link 58 reacts against rod 30 causing the door to slide easily to LEFT or RIGHT. Spring 60 overcomes resistance to initial movement.

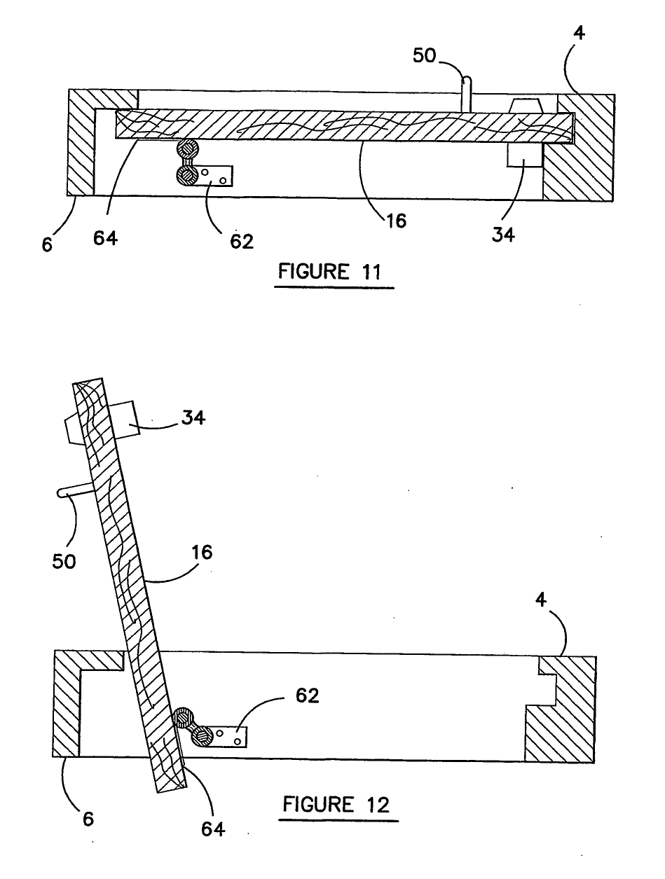

In FIGS. 11 and 12, the upstands are not used because a timber security door has a closing style 4 and an L-section support style 6. Frame hinges 22, 24 are secured to the door casing by end plates 62 and the door hinges are screwed to the door by hinge leaves 64. Handle 50 and lock 34 are conventional.

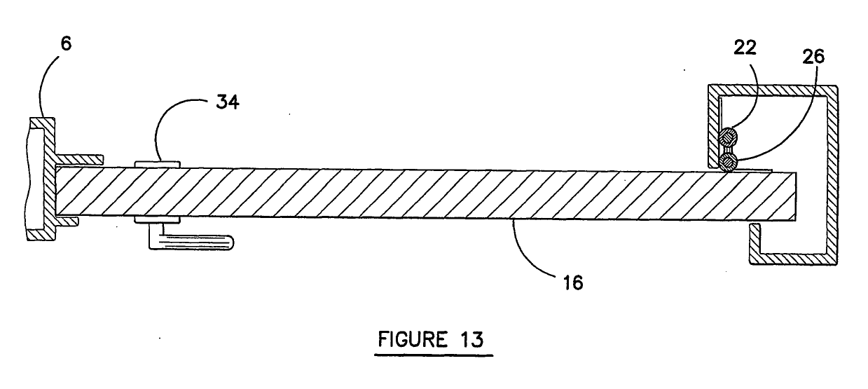

In FIG. 13, the frame hinges 22, 24 (one shown) and door hinges 26, 28 (one shown) have hinge leaves 64 which are all accommodated inside support stud 4. Support stud 4 and closing stud 6 are hollow aluminium extrusions. Lock 34 has diverging hooks which open out inside hollow stud 6.

The aluminium security door shown in FIG. 13 has a hinge assembly which may be sold separately and this is shown in FIG. 14. Rod 30 joins the pockets of frame hinges 22, 24 so they tilt in unison. The pockets of the hinges 22,24 are joined to the pockets of the door hinges 26, 28 by welds 66.

In FIG. 15, the throw of the hinge assembly is increased by using triple hinges welded together as sets. The door is prevented from sagging by joining the door hinges to the door and the frame hinges by rod 30 and the intermediate hinges 68 by intermediate rod 70.

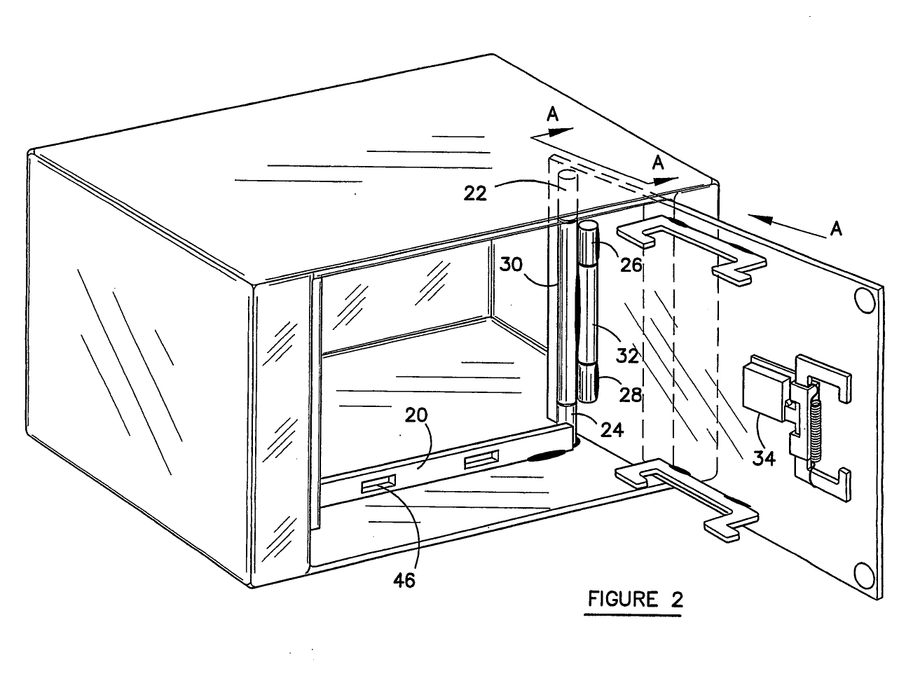

In a gun safe shown in FIG. 16, the pockets of the frame hinges 22, 24 are connected to the pins of the door hinges 26, 28. The hooks 48 and slots 46 engage and disengage as in the embodiment shown in FIGS. 2 and 3. An ammunition box 72 leaves space for a weapon 74.

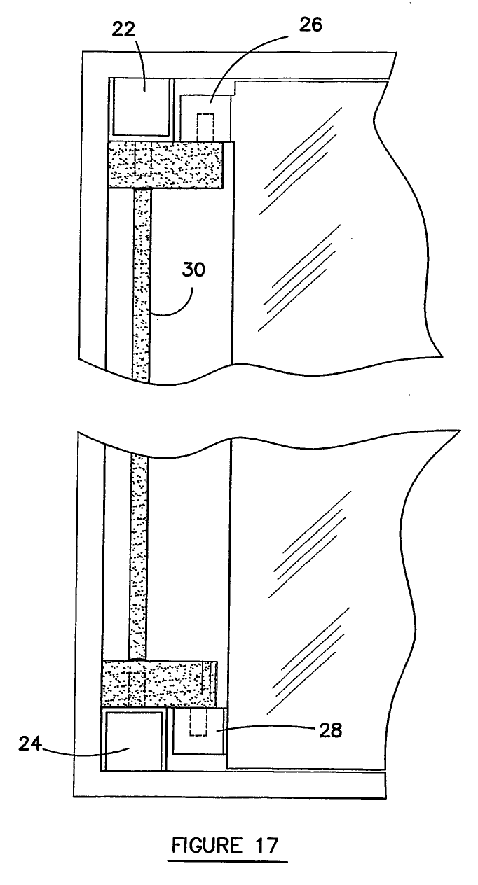

FIG. 17 assists in understanding the offset motion of the door. The components which are stippled lie in one plane and behave as a unitary part in the hinge assembly in the manner of a radius arm.

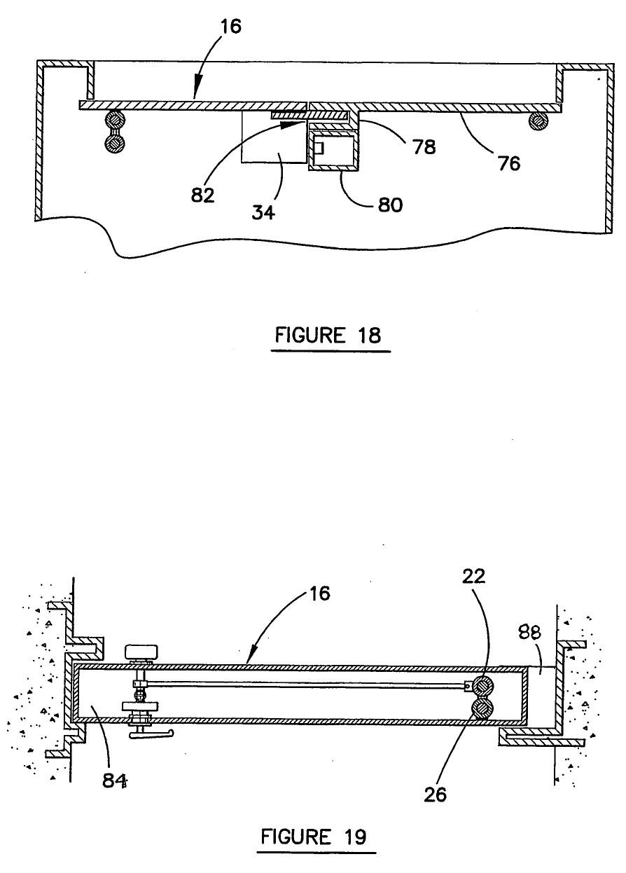

When a walk-in safe is constructed as for a cigarette and alcohol store, gunrooms, armouries and the like, a conventional door 76 (FIG. 18) has a longitudinal pocket 78 at the closing edge which closes to the central pillar 80 and defines a slot 82 into which the sliding door 16 projects in order to allow lock 34 to operate.

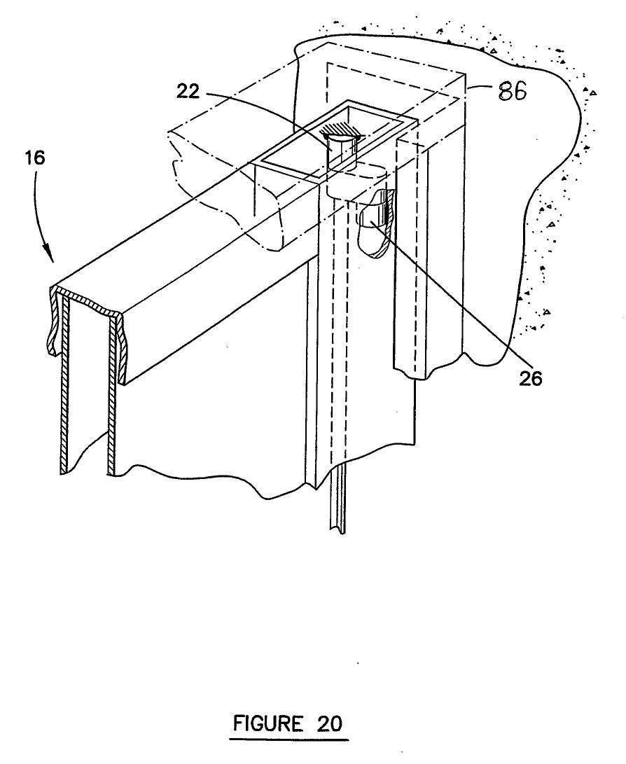

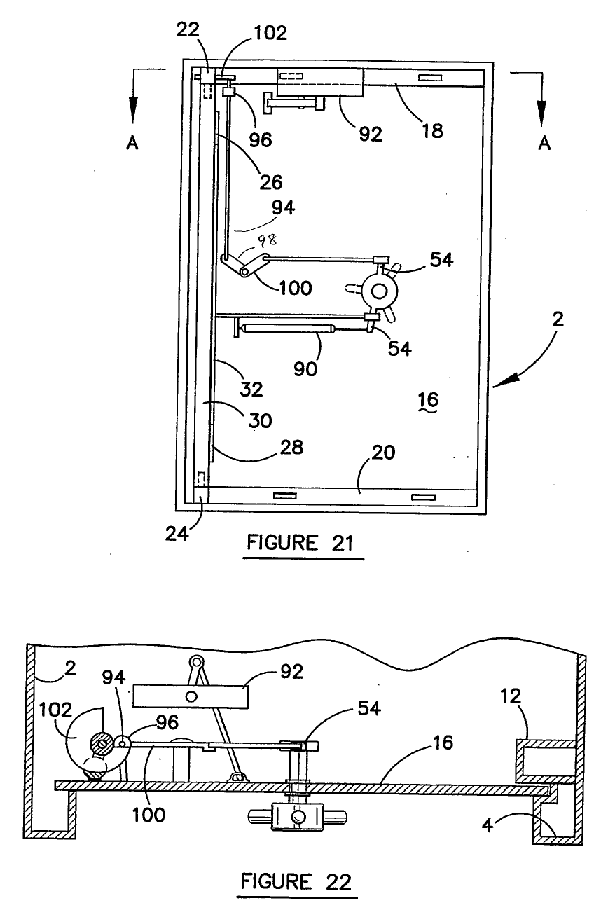

In FIGS. 19 and 20, steel plate door 16 has a hollow interior 84. The hinge assembly is housed in the interior, the door hinge 26 being welded to the inside of the door and the frame hinge 22 being welded to the door frame header 86 and the floor bar 88.

Door handle 52 connects to crank 54 and link 58 reacts against rod 30 causing the door to slide easily LEFT or RIGHT. Crank 54 is also acted upon by gas strut 90 which tends to move the door to the RIGHT thereby pushing the door into the door slot. A conventional door closer 92 is mounted inside the safe on the roof as shown.

The cranks movement in response to the force of the gas strut is resisted by a rod 94 which rises and falls in collar 96 under the influence of rigid connector 98 and bell crank 100. Rod 94 describes an arc when the door 16 opens and is prevented from rising and imparting the force of the gas strut to the door by contact with the underside of arcuate stop 102. The stop is stationary and extends from frame hinge 22. When the door closer swings the door closed and the door lands on the closing surface of style 4, rod 94 reaches the end of the stop and suddenly rises under the force of the gas strut. The handle is subjected to a force sliding the door to the RIGHT and is free to move on the hinge assembly because the latter has an offset configuration.

When closed, the end of rod 94 projects above the arcuate stop 102. Turning the handle pulls rod 94 under the stop and swinging the door open against the closer retains the rod 94 under the stop. When the handle is released, the door closer swings the door shut but the sliding motion is delayed until the door registers with the slot.

In another version, the gas strut drives a pair of bolts into keepers in the closer 12.

We have found the advantages of the above embodiment to be:
1. The usual sites for the prying bar are absent in the construction.
2. No multiple entry bolts are necessary.
3. Doors of considerable mass are easily moved.
4. The fall width of the door is available.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

1-29. (canceled)

30. A security door construction comprising a door frame having a door hanging upright and a closing upright against which the door closes, a door slot associated with the closing upright, a door with a hung edge and a closing edge and an offset hinge assembly mounted on the hanging upright which supports the door, whereby upon closing the door slides into the door slot and upon opening slides out of the door slot.

31. A safety door construction as claimed in claim 30, wherein the offset hinge assembly comprises a first pair of hinges connected to the door hanging upright, a second pair of hinges connected to the hung edge door and each hinge is having a hinge axis means connecting first and second pairs which maintains the hinge axis of the first pair parallel to the hinge axis of the second pair.

32. A security door construction as claimed in claim 31, wherein the means is a rigid member connecting the pockets of one pair of hinges to the pins of the other pair of hinges.

33. A safety door construction as claimed in claim 31, wherein the means is a rigid member connecting the pins of one pair of hinges to the pins of the other pair of hinges.

34. A safety door construction as claimed in claim 31, wherein the means is a rigid member connecting the pockets of one pair of hinges to the pockets of the other pair of hinges.

35. A safety door construction as claimed in claim 31, wherein the rigid member is a rod.

36. A security door construction as claimed in claim 31, wherein the hinge pockets of one pair of hinges are fixed to the adjacent hinge pockets of the other pair and the rod connects the leaves of the pair of hinges connected to the frame.

37. A security door construction as claimed in claim 31, wherein each pocket of the pair of hinges which is fixed to the frame is welded at its end to the top and bottom horizontal face of the frame and the body of the pocket is additionally welded to an upstand also welded to the top or bottom face of the frame.

38. A security door construction as claimed in claim 31, wherein the uprights of the frame are box section styles.

39. A security door construction as claimed in claim 38, wherein the door slot is in the closing style.

40. A security door construction as claimed in claim 38, wherein the frame is part of the safe and the body of the safe is made of a single plate panel which is formed into a channel section including the box section styles braced by a top plate and a bottom plate.

41. A security door construction as claimed in claim 30, wherein the slide motion is 15-25 mm.

42. A security door construction as claimed in claim 30, wherein the door has a rear face with a top edge and a bottom edge, the door frame has a top rail lying behind the top edge of the door and a bottom rail lying behind the bottom edge of the door, each rail defines slot means therein and the corresponding area on the rear face of the door has hook means for engaging and disengaging the slot means when the door closes and opens.

43. A security door construction as claimed in claim 31, wherein the door is substantially planar and the door frame has a closing surface parallel to the plane of the closed door against which the door tilts to close before the door reaches the door slot.

44. A security door construction as claimed in claim 43, wherein the closing frame member is a channel section style and adjacent parallel L-section member fixed to the frame defines with the closing style, the slot for the door.

45. A security door construction as claimed in claim 31, wherein the upright members of the door frame are made of channel-section styles and an adjacent parallel L-section member fixed to the frame adjacent the door hanging style acts as a hinge support.

46. A security door construction as claimed in claim 35, wherein the door has a rotatable handle for opening and closing the door, the handle having a link which reacts against the rod joining the frame mounted hinges, causing the door to slide left or right when the handle is rotated.

47. A security door construction as claimed in claim 46, wherein the handle rotates between stops and a spring assists rotation by biassing the rotation toward one or other stop.

48. A security door construction as claimed in claim 31, wherein the door frame has a handle and a sill frame hinges are adapted for fixing to the header and sill of the door frame and the door hinges are adapted for fixing to the door.

49. A security door construction as claimed in claim 31, wherein the door is a screen door made of hollow metal extrusions with pairs of edges, and the frame hinges are adapted for fixing to a face of the frame and the door hinges are adapted for fixing to an edge of the door.

50. A security door construction as claimed in claim 48, wherein the hinge assembly is at least partly housed in the door itself.

51. A security door construction as claimed in claim 50, wherein the door hanging style defines a tunnel and the hinge assembly is housed in the tunnel at or near the support edge of the door.

52. A security door construction as claimed in claim 43, having a door closer arranged to bias the door shut in known manner and a biassing assembly associated with the door capable of sliding the door into the door slot when the door closer brings the door into register with the door slot.

53. A security door construction as claimed in claim 52, wherein the door movement caused by the biassing assembly is delayed until the door lands on the closing surface of the frame adjacent the door slot.

54. A security door construction as claimed in claim 53, wherein the biassing assembly comprises a door handle with a crank inside the door which reacts against the rod extending between the frame pivots, biassing means acting between the inside of the door and the crank in order to urge the door to slide toward the door slot, a link assembly connected to the crank which restrains the biassing means from imparting such slide motion to the door and a stop extending over at least part of the doors arc of swing which releases the link assembly at the end of the arc when the door registers with the door slot.

55. A security door construction as claimed in claim 54, wherein the arcuate stop is concentric with the hinge axis of the frame hinges.

56. A safe containing a door construction as claimed in claim 30.

57. A pre-hung door comprising a casing and a security door construction as claimed in claim 48.

58. A hinge assembly for a security door construction as claimed in claim 30, comprising a first pair of hinges connectable to a frame and a second pair of hinges connectable to a door and rod or tube connecting the frame hinges together so that the pockets of the first pair are fixed to the pockets of the second pair.
